(19) United States
(12) Patent Application Publication
(10) Pub. No.: US 2022/0001406 A1
(43) Pub. Date: Jan. 6, 2022

(54) PAINT CUP FOR A SPRAY GUN AND SPRAY GUN

(71) Applicant: Martin Ruda 1. UG (haftungsbeschraenkt), Ostfildern (DE)

(72) Inventor: Martin RUDA, Ostfildern (DE)

(73) Assignee: Martin Ruda 1. UG (haftungsbeschraenkt), Ostfildern (DE)

(21) Appl. No.: 17/291,339

(22) PCT Filed: Sep. 26, 2019
(86) PCT No.: PCT/DE2019/000255

§ 371 Date: May 5, 2021

(30) Foreign Application Priority Data
Nov. 6, 2018 (DE) 10 2018 008 686.1
Mar. 7, 2019 (DE) 10 2019 001 534.7

(51) Int. Cl. B05B 7/24; B05B 15/40

(52) U.S. Cl. CPC B05B 7/2408; B05B 15/40; B05B 7/2478

(57) ABSTRACT

A paint cup for a spray gun has a cup part and a lid which are connected to one another so as to be sealed at an opening which is round in cross-section. According to the invention, the lid has at least one dimensionally stable wing projecting radially from the round opening, which wing is designed such that a force can be exerted on the lid via it when removing the lid in order to move the lid and cup part relative to one another.

The invention relates to a paint cup for a spray gun and a spray gun.

Paint cups for a spray gun have a cup part in which the paint can be mixed and a lid via which the paint cup is connected to a spray gun in such a manner that paint can flow from the cup to the spray gun.

The invention thus relates in particular to flow cups which are placed on the spray gun with the lid part facing downwards. The lid is unscrewed from the cup part in order to mix paint. Various types of threads can be used as a screw cap, in particular a bayonet fitting. The lid can also be removed from the cup part as a slip lid. A slip lid is usually placed on the cup part in a latching manner.

If the cup part has a vent, such as a closable opening in the base of the cup, the vent in the cup part is closed when mixing and storing paint, whereas the vent in the cup part is open for spraying the paint.

Various transition zones between the cup part and the lid are known, which are intended to ensure that paint wetting the connection does not escape at the transition region between the cup part and lid. The closure is intended to create a reliable seal, on the one hand, and also ensure that no paint drips onto the work surface when screwing and unscrewing the lid, on the other hand.

The lid usually surrounds the cup part and an internal thread of the lid interacts with an external thread of the cup part. However, a slip lid can also surround the cup part and press the lid against the cup part.

A pressure acting radially from outside on the lid during screwing on and unscrewing thus initially acts radially on the cup in the upper region of the cup part and then on a circumferential web extending from the lid into the cup part, which web is attached to the lid. As a result, such a radial force is first absorbed by the cup and then by the web of the lid without the fear of leaks.

In the case of a slip lid, the contact surfaces of the lid and cup part are pressed against each other in the closed state in such a way that a liquid-tight and usually also gas-tight seal is guaranteed.

Such cups can be produced with very good sealing properties with precisely adjusted fits, even in extremely large quantities. However, it may be the case that either the paint sticks the cup part and lid together or in particular also the materials of the cup part and lid abut one another in such a manner that the sticking or adhesion to the circumferential surface makes opening the lid or unscrewing the lid from the cup part more difficult. In particular the contact surface between the cup part and lid provided for sealing, which is usually also provided by a circumferential web leads, on the one hand, to reliable sealing being achieved, which, as an air-tight seal, prevents the paint from drying up in the cup part. On the other hand, however, this makes opening the lid more difficult, as even radial pressure does not lead to the parts being detached from one another, but only presses the surfaces of the lid and cup part more firmly together due to the provision of the radially inner web.

The object of the invention is therefore to develop a paint cup, which is securely sealed so as to be air-tight and paint-tight, on the one hand, but is also easy to open, on the other.

This object is achieved with a paint cup having the features of patent Claim 1. Advantageous further developments are the subject of the dependent claims.

Whilst it was previously assumed that a radial force acting on the rim of a cup, in particular from opposite sides, loosens adhesion between the lid and cup part, the invention is based on the realization that easier loosening is achieved by using a radially projecting wing as a lever which makes it easier to exert a loosening force on the connection between the cup part and lid and also causes a targeted bending of the lid and cup part which makes it easier to loosen the cup part and lid.

Whilst it was previously assumed that in the case of parts made of plastic for the lid and cup part, the flexibility of the materials makes loosening the connection easier, the inventor assumes that also in the case of slip or screw caps with an elastic lid and elastic cup part, in particular in the case of a web of the lid resting radially on the inside of the cup, it is above all a force applied in a targeted manner via a wing acting as a lever that makes loosening the connection between the lid and cup part easier.

For this purpose, depending on the application, radial wings with different curvatures are provided for right-handed and left-handed users, which, lying close together, can also laterally limit between them a cap which is moulded on in a manner such that it can be pulled off, in order to prevent unintentionally loosening the cap.

Fortunately, it has been found that these wings proposed for such disposable spray gun cups make loosening the lid easier, in particular also in the case of structures additionally provided on the circumferential surface which increase the frictional resistance as a special contact surface.

Advantageous embodiments are shown in the drawing. A person skilled in the art will take different advantageous embodiments from the figures of the drawing.

In the figures

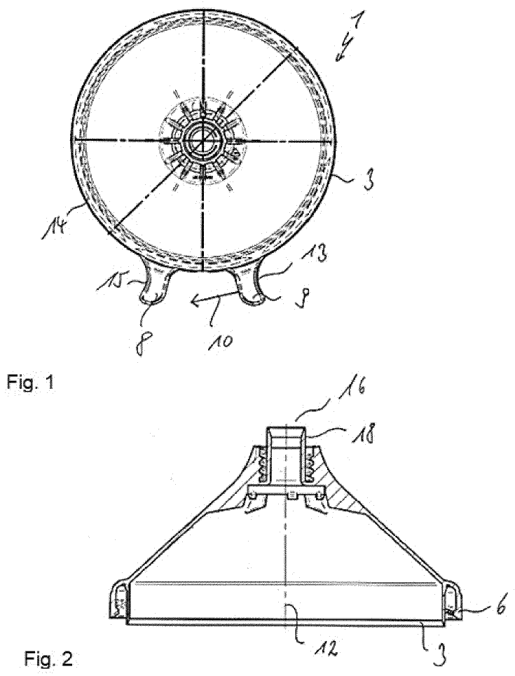

FIG. 1 shows a plan view of a lid of a paint cup,

FIG. 2 shows a section through the lid shown in FIG. 1,

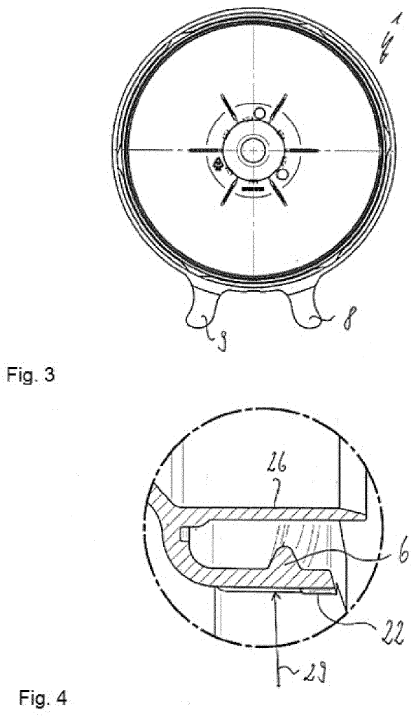

FIG. 3 shows a view of the lid shown in FIG. 1 from below,

FIG. 4 shows an enlarged section of the edge area of the lid shown in FIG. 2,

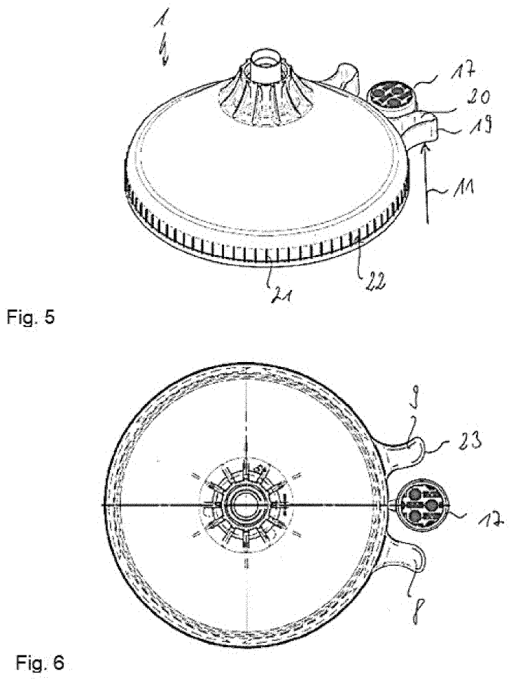

FIG. 5 shows a perspective view of a lid with a cap,

FIG. 6 shows a plan view of the lid shown in FIG. 5,

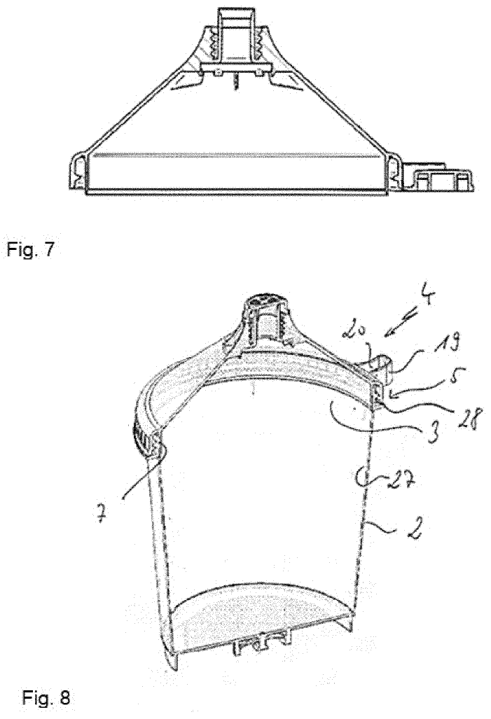

FIG. 7 shows a section through the lid shown in FIGS. 5 and 6,

FIG. 8 shows a perspective section through a cup part with the lid shown in FIG. 5,

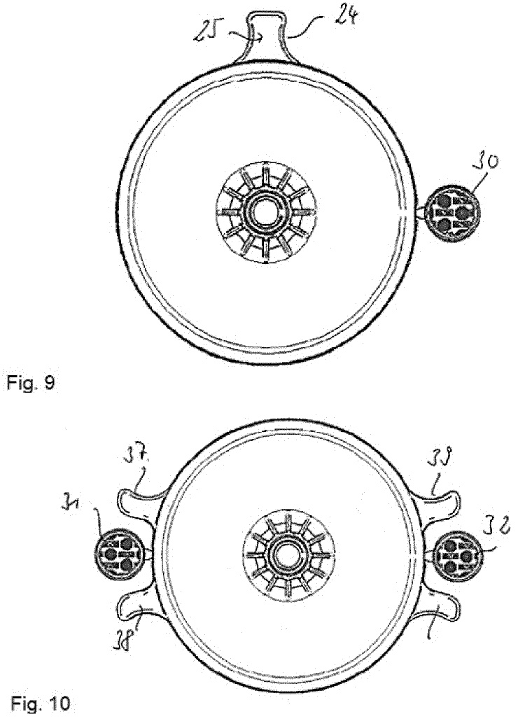

FIG. 9 shows a plan view of a lid having only one wing and one cap,

FIG. 10 shows a plan view of a lid having two wings on each side and a cap between each of them,

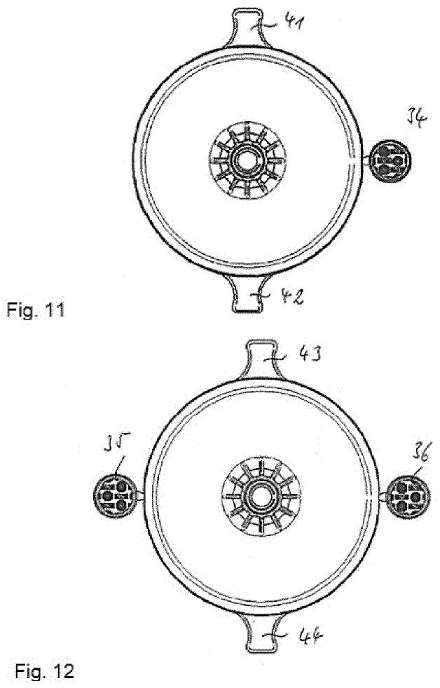

FIG. 11 shows a plan view of a lid having two wings and a cap,

FIG. 12 shows a plan view of a lid having two wings and two caps,

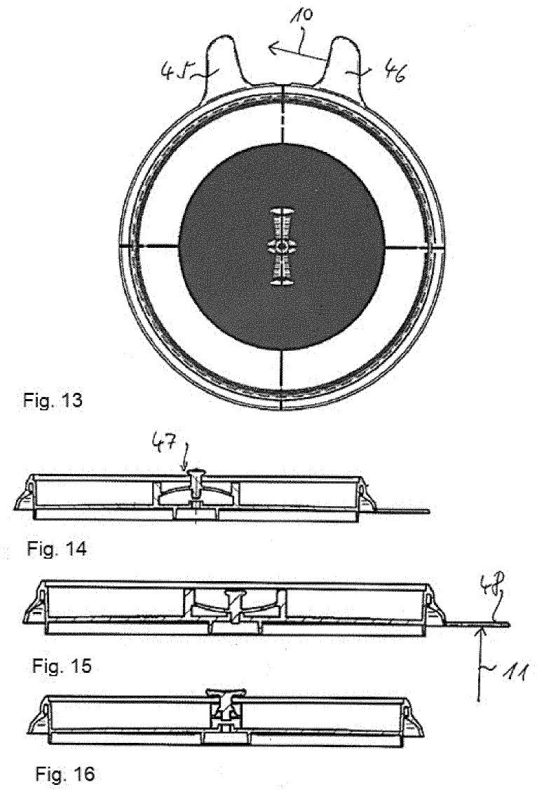

FIG. 13 shows a plan view of a slip lid having two wings,

FIG. 14 shows a section through the slip lid shown in FIG. 13 with open access,

FIG. 15 shows a section through the lid shown in FIG. 13 with closed access,

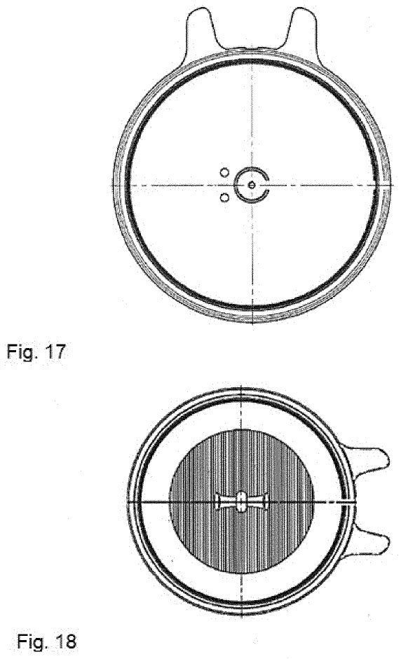

FIG. 16 shows a further view of the lid shown in FIG. 14,

FIG. 17 shows a bottom view of the lid shown in FIG. 13,

FIG. 18 shows a lid similar to the one shown in FIG. 13,

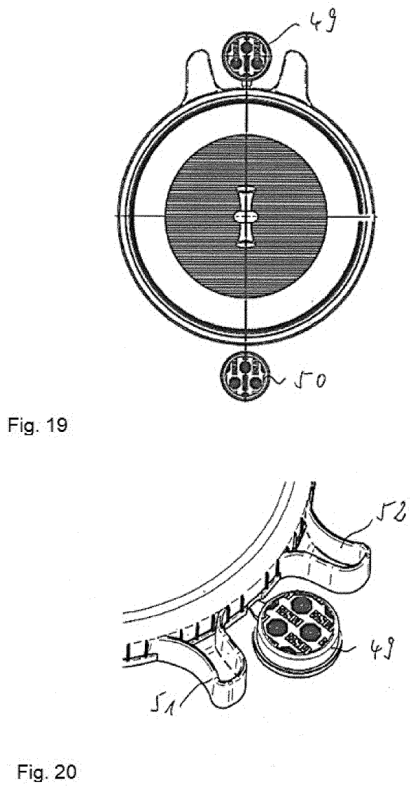

FIG. 19 shows a slip lid having two wings and a cap in between and opposite,

FIG. 20 shows a perspective view of a section of the slip lid shown in FIG. 19,

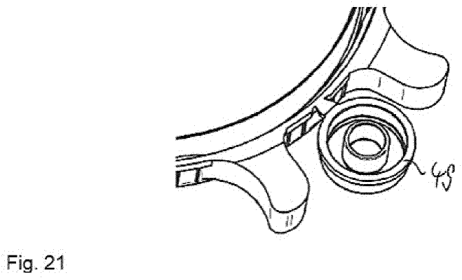

FIG. 21 shows the section shown in FIG. 20 from the opposite side.

The lid 1 shown in FIG. 1 can be screwed onto a paint cup part 2 shown in FIG. 8 in order to cover an opening 3, which is round in cross-section, of the cup part 2 with the lid 1. Screwing the lid 1 onto the cup part 2 results in a paint cup 4 for a spray gun (not shown). The screw connection 5 consists of a lid thread 6, which interacts with a cup thread 7, in order to connect the cup part 2 and lid 1 to one another so as to be sealed at the round opening 3.

The lid 1 has two dimensionally stable wings 8, 9 projecting from the round opening 3, which wings 8, 9 are designed such that a force can be exerted on the lid 1 via these dimensionally stable wings 8, 9 when removing the lid 1 from the cup part 2 in order to move the lid 1 relative to the cup part 2.

The wings 8, 9 are thus not designed like a lug for radial or tangential pull, rather they are designed to be so stable and connected to the rest of the lid 1 that a force 10 acts tangentially to the round opening 3 via the wings in the present exemplary embodiment.

The lid 1 can be slipped onto the cup part 2 with or without a thread. In this case, a force 11 can also act parallel to the central axis 12 of the round opening 3.

Within the scope of the accompanying exemplary embodiments, the lid 1 and cup part 2 are respectively made of plastic. Polyethylene was selected for the lid, and polypropylene for the cup part. This gives the lid a special strength that allows the wings 8, 9 to be dimensionally stable in order to exert a force 10 tangentially to the round opening and/or a force 11 parallel to the central axis 12 of the round opening as necessary. This makes it easier to put or screw the lid 1 onto the cup part 2, on the one hand, and to remove the lid 1 from the cup part 2 again, on the other.

This in turn means that the lid 1 and cup part 2 can be designed with a large contact surface with one another without having to fear that this contact surface will make opening the lid more difficult due to adhesive forces or sticking.

In order to be able to provide a good contact surface 13 over which pressure can to be applied to one of the wings 8, 9 with the thumb of the hand, for instance, it is advantageous if the wing 8, 9 extends radially outwards from the circumference 14 of the lid 1 by approximately 1 cm. It is advantageous in an orientation perpendicular to the radial extension if the wing 8, 9 extends approximately 0.5 cm parallel to the central axis 12 of the round opening 3. It is particularly advantageous if the contact surface 13 is designed to be concave as this makes it easier to also exert a relatively large force 10 on the wing 8, 9 with the thumb, for instance. In the exemplary embodiment shown in FIG. 1, two wings 8, 9 are moulded on the lid 1 and have concave contact surfaces 13, 15 curved in opposite directions.

In particular if the lid 1 has a plurality of wings 8, 9 and a closable paint opening 16, a cap 17 can be moulded on the lid 1 and is preferably arranged between two wings 8, 9 on one side of the round opening 3. This cap 17 can be fitted onto a central screw connection 18 if this is not required for connection to a spray gun (not shown).

FIGS. 5 and 8 show that the wings 8, 9 respectively have an outer contour 19 which surrounds a hollow body 20. In this case, the wing 8, 9 is moulded onto an outer contour 22 of the lid 1 provided with vertical ribs 21 in a strip-like manner. This results in a bell-shaped contour 23 in cross-section on the wings 8, 9, which does not have to be symmetrical but, as FIG. 9 on the contour 24 of the wing 25 shows, can also be symmetrical.

FIG. 4 shows that the lid 1 has a circumferential web 26 which, when the lid 1 is in place, extends into the cup part 2 and abuts the inner wall 27 of the cup part 2 in the upper region. The thread 6 of the lid 1 is opposite the web 26. As a result, the upper rim 28 of the cup part 2 is received between the web 26 and the thread 6.

A force 29 applied perpendicularly to the outer contour 22 of the lid 1, thus presses against the upper rim 28 of the cup part 2 and is absorbed by the web 26 acting as an abutment. A particularly stable design in this area makes it more difficult to loosen adhesions between the lid 1 and cup part 2 by deforming them. On the other hand, a stable design in this area improves the tightness. The design of the wings 8, 9 on the lid 1 thus makes it possible to make the area at the upper rim 28 of the cup part 2 and in particular the lid area adjacent to it particularly stable in order to achieve a special tightness whilst the opening of the lid 1 is made easier by the wings 8, 9.

FIGS. 9 to 21 show different arrangements of lids 30 to 36 and wings 37 to 46. FIGS. 13 to 21 show embodiments of slip lids. These slip lids have a closable air supply opening 47 and the wings can be designed as a plate 48 in the simplest case and, as shown in FIGS. 19 to 21, can receive a cap 49 or 50 between them. The easily detachable moulded cap 49 is protected by the wings 51, 52, which prevents the cap 49 being inadvertently detached from the lid 1.

The lid 1 has a frusto-conical portion, on the smaller diameter of which the screw connection 18 is arranged. The lid 1 usually has a sieve (not shown), which is preferably designed as a removable sieve and arranged at the screw connection 18.

One embodiment not shown envisages that the lid has at least one recess formed in the lid or one web formed on the lid, which are designed such that a force can be exerted on the lid via the web or the recess when removing the lid 1 in order to move the lid and cup part relative to one another. The wing, recess or web can be provided anywhere on the lid. If the lid has a frusto-conical surface, the wing, recess or web can be formed not only in the region of the round opening but also on the frusto-conical surface.

1: A paint cup (4) for a spray gun having a cup part (2) and a lid (1) which are connected to one another so as to be sealed at an opening (3) which is round in cross-section, wherein the lid (1) has at least one dimensionally stable wing (8, 9) projecting radially from the round opening (3), which wing (8, 9) is designed such that a force (10, 11) can be exerted on the lid (1) via it when removing the lid (1) in order to move the lid (1) and cup part (2) relative to one another.

2: The paint cup according to claim 1, wherein the cup part (2) and lid (1) are screwed together and the force (10) acts tangentially to the round opening (3).

3: The paint cup according to claim 1, wherein the lid (1) is slipped onto the cup part (2) and the force (11) acts parallel to a central axis (12) of the round opening (3).

4: The paint cup according to claim 1, wherein the lid (1) and the cup part (2) are made of plastic.

5: The paint cup according to claim 1, wherein the lid (1) is made of polyethylene.

6: The paint cup according to claim 1, wherein the cup part (2) is made of polypropylene.

7: The paint cup according to claim 1, wherein the wing (8, 9) extends radially outwards from the circumference (14) of the lid (1) by approximately 1 cm.

8: The paint cup according to claim 1, wherein the wing (8, 9) extends approximately 0.5 cm parallel to the central axis (12) of the round opening (3).

9: The paint cup according to claim 1, wherein the lid (1) has on the wing (8, 9) a concave contact surface (13, 15) extending radially outwards from the circumference (14) of the lid (1).

10: The paint cup according to claim 9, wherein the lid (1) has concave contact surfaces (13, 15) curved in opposite directions on one or two wings (8, 9).

11: The paint cup according to claim 1, wherein the lid (1) has a plurality of wings (8, 9).

12: The paint cup according to claim 1, wherein the cup part (2) has a closable paint opening (16).

13: The paint cup according to claim 1, wherein the lid (1) has a central screw connection (18) for connection to a spray gun.

14: The paint cup according to claim 13, wherein the lid (1) has a frusto-conical portion, on the smaller diameter of which the screw connection (18) is arranged.

15: The paint cup according to claim 13, wherein the lid has a sieve which is arranged at the screw connection (18).

16: The paint cup according to claim 1, wherein the lid (1) has a cap (17) which is molded on in a manner such that it can be pulled off.

17: The paint cup according to claim 14, wherein the molded-on cap is arranged between two wings (8, 9), which are arranged on one side of the round opening (3).

18: The paint cup according to claim 1, wherein the wing (8, 9) has an outer contour (19), which surrounds a hollow body (20).

19: The paint cup according to claim 1, wherein the wing (8, 9) is moulded molded onto an outer contour (22) of the lid (1) in a strip-like manner.

20: The paint cup according to claim 1, wherein the wing (8, 9) has a bell-shaped contour (23, 24) in cross-section.

21: The paint cup according to claim 1, wherein the lid (1) has a circumferential web (26), which extends into the cup part (2) and abuts the inner wall (27) of the cup part (2).

22: The paint cup according to claim 1, for a spray gun having a cup part (2) and a lid (1) which are connected to one another so as to be sealed at an opening (3) which is round in cross-section, wherein the lid (1) has at least one recess formed in the lid or one web formed on the lid, which are designed such that a force (10, 11) can be exerted on the lid (1) via the web or the recess when removing the lid (1) in order to move the lid (1) and cup part (2) relative to one another.

23: The paint cup according to claim 1, wherein the lid has a frusto-conical surface on which the wing, recess or web are formed.

24: A spray gun having the paint cup (4) according to claim 1.
